(19) United States
(12) Patent Application Publication
(10) Pub. No.: US 2022/0101097 A1
(43) Pub. Date: Mar. 31, 2022

(54) METHOD AND DEVICE FOR CLUSTERING FORECASTING OF ELECTRIC VEHICLE CHARGING LOAD

(71) Applicants: NORTH CHINA ELECTRIC POWER UNIVERSITY, Beijing (CN); STATE GRID ELECTRIC VEHICLE SERVICE CO., LTD., Beijing (CN)

(72) Inventors: Dunnan LIU, Beijing (CN); Mingguang LIU, Beijing (CN); Xiaofeng PENG, Beijing (CN); Wen WANG, Beijing (CN); Yue ZHANG, Beijing (CN); Ye YANG, Beijing (CN); Mengjiao ZOU, Beijing (CN); Heping JIA, Beijing (CN); Desheng BAI, Beijing (CN); Shu SU, Beijing (CN)

(21) Appl. No.: 17/362,343

(22) Filed: Jun. 29, 2021

(30) Foreign Application Priority Data
Sep. 28, 2020 (CN) 202011041068.6

(51) Int. Cl. G06N 3/04; G06N 20/10

(52) U.S. Cl. CPC G06N 3/0436; G06N 20/10

(57) ABSTRACT

The present disclosure relates to a method for clustering forecasting of the electric vehicle charging load, comprising the following steps: collecting electric vehicle charging load data on a historical date and weather information data related to that historical date; preprocessing and then normalizing the collected data to obtain a new data set; performing fuzzy C-means clustering on the normalized data, and taking an actual load measurement point as a fuzzy clustering index to construct a similar daily load set of the date to be forecast; according to the similar daily load set, constructing and training a least-square SVM (support vector machine) forecasting model; inputting load values at the same time in three days ahead of the date to be forecast and the weather information data related to the three days into the trained least-square SVM forecasting model, and outputting a forecast load.

### CROSS REFERENCE TO RELATED APPLICATION(S)

This patent application claims the benefit and priority of Chinese Patent Application No. 202011041068.6, filed on Sep. 28, 2020, the disclosure of which is incorporated by reference herein in its entirety as part of the present application.

### TECHNICAL FIELD

The present disclosure relates to the technical field of automatic control of power systems, and particularly to a method and a device for clustering forecasting of electric vehicle charging load.

### BACKGROUND ART

With the large-scale grid-connected operation of electric vehicles, the impact due to the growth of electric vehicle charging load on the power system, especially the distribution network, has become increasingly prominent. On one hand, the change of electric vehicle charging load leads to the fluctuation of the line load rate and the decrease of power supply reliability, thus increasing the difficulty of the distribution network upgrading and reconstruction. On the other hand, the disorderly charging of electric vehicles increases the load peak, which requires new installed capacity and reduces the operation efficiency of the system. The electric vehicle charging load forecasting is the foundation of improving the power grid regulation and control ability, as well as carrying out orderly charging and discharging. As electric vehicles pertain to an emerging industry, their charging load is different from the traditional one, which is featured by strong uncertainty and volatility in time and space distribution. Obviously, methods for traditional load forecasting are not fully applicable to the forecasting of electric vehicle charging load. The electric vehicle charging load is affected by many factors such as weathers, date types and user behaviors, and forecasting methods in the prior art cannot fully take all these factors into consideration, resulting in a poor forecasting effect. Therefore, it is urgent to accurately forecast the electric vehicle charging load.

In view of these problems, it is of great practical significance to provide a method and a device for clustering forecasting of the electric vehicle charging load which fully take into consideration the properties such as date types, weather factors and weekly attributes.

### SUMMARY

The present disclosure intends to provide a method and a device for clustering forecasting of the electric vehicle charging load which fully take into consideration the properties such as date types, weather factors and weekly attributes.

A technical scheme adopted in the present disclosure to solve the problems is implemented as follows:

The method for clustering forecasting of the electric vehicle charging load includes the following steps:

Collecting electric vehicle charging load data on a historical date and weather information data related to that historical date;

Preprocessing and then normalizing the collected data to obtain a new data set;

Performing fuzzy C-means clustering on the normalized data, and taking an actual load measurement point as a fuzzy clustering index to construct a similar daily load set of the date to be forecast;

According to the similar daily load set, constructing and training a least-square SVM (support vector machine) forecasting model;

Inputting load values at the same time in three days ahead of the date to be forecast and the weather information data related to the three days into the trained least-square SVM forecasting model, and outputting a forecast load.

Furthermore, the method of performing fuzzy C-means clustering on the normalized data and taking the actual load measurement point as the fuzzy clustering index to construct the similar daily load set of the date to be forecast is as follows:

(1) A fuzzy C-means clustering model is constructed, and the measured data points of a daily load curve are taken as the characteristic quantity for fuzzy clustering:

X={x₁,x₂, . . . ,xₙ}∈R′

In the formula, X is a sample set of a given load, S represents the dimension of the sample, and n is the number of samples, namely the number of load curves involved in clustering;

$$minJ ( U , V ) = {\sum }_{i = 1}^{c} {\sum }_{j = 1}^{n} {u}_{ij}^{m} {d}_{ij}^{2}$$

$${\sum }_{i = 1}^{c} {u}_{ij} = 1 , 1 \leq j \leq n$$

$${\sum }_{i = 1}^{n} {u}_{ij} > 0 , 1 \leq i \leq c$$

In this formula, U is a fuzzy dividing matrix, V is a clustering center matrix, uᵢⱼ is the subordination of the sample xᵢ relative to the class j, dᵢⱼ the euclidean distance from the sample xⱼ to the clustering center vᵢ, m is a fuzzy degree weighted index, which controls the fuzzy degree of clustering, and c is a cluster number of clustering.

(2) An alternating optimization strategy is adopted to solve the fuzzy C-means clustering model, so as to obtain a similar daily load set of the date to be forecast is obtained.

Further, the method of solving the fuzzy C-means clustering model by the alternating optimization strategy is as follows:

Initialization: by determining the values of c and m of the sample set X and the) iterative error threshold ε, an initial subordination matrix will be U⁽⁰⁾=uᵢⱼ⁽⁰⁾;

The clustering center vᵢ is determined:

$${v}_{i}^{( 1 )} = \frac{{\sum }_{j = 1}^{n} {( {u}_{ij}^{( 1 - 1 )} )}^{m} {x}_{j}}{{\sum }_{i = 1}^{n} {( {u}_{ij}^{( 1 - 1 )} )}^{m}} ( i = 1 , 2 , … , c )$$

The subordination uᵢⱼ and objective function value min J⁽¹⁾ are calculated:

$${u}_{ij}^{( 1 )} = \frac{1}{{\sum }_{k = 1}^{c} {( \frac{{d}_{ij}^{( 1 )}}{{d}_{kj}^{( 1 )}} )}^{\frac{2}{m - 1}}} ( i = 1 , 2 , … , c ; j = 1 , 2 , … , n )$$

$$min {J}^{( 1 )} ( {U}^{( L )} , {V}^{( L )} ) = {\sum }_{i = 1}^{c} {\sum }_{j = 1}^{n} {( {u}_{ij}^{( 1 )} )}^{m} {( {d}_{ij}^{( 1 )} )}^{2}$$

Iterative error judgment: if it satisfies

max |uᵢⱼ^{l}−uᵢⱼ^{l-1}|<ε

The iteration ends, or otherwise returns to calculate a new clustering center for continuing the iteration, and the sample category is determined according to the principle of maximum subordination.

Furthermore, according to the obtained similar daily load set of the date to be forecast, constructing and training a least-square SVM (support vector machine) forecasting model:

The regression estimation function is:

f(x)=ω^{T}·ϕ(x)+b

Wherein ω is a weight vector; φ(x) is a mapping function; b is an offset term, and ω^{T} represents the transposition of ω. At this moment, the objective function and the constraint are:

$$minJ ( ω , e ) = \frac{1}{2} {‖ ω ‖}^{2} + \frac{1}{2} C {\sum }_{i = 1}^{l} {e}_{i}^{2}$$

$$s . t . {y}_{i} = {ω}^{T} \cdot ϕ ( {x}_{i} ) + b + {e}_{i} , i = 1 , 2 , … , l$$

In this formula, eᵢ is the error; e∈R^{l×l} is the error vector; C is the penalty coefficient which affects the complexity and stability of the model. According to the reference of the prior art, the significance of over-large and over-small value setting of C can be artificially set, and the Lagrange multiplier λ can be introduced, so that λ∈R^{l×l}, in order to transform the model into an unconstrained optimization problem:

$$L ( ω , b , e , λ ) = \frac{1}{2} {‖ ω ‖}^{2} + \frac{1}{2} C {\sum }_{i = 1}^{l} {e}_{i}^{2} - {\sum }_{i = 1}^{l} {λ}_{i} [ {ω}^{T} \cdot ϕ ( {x}_{i} ) + b + {e}_{i} ] - {y}_{i}$$

According to Karush-Kuhn-Tucker (KKT) conditions:

$$\{ \begin{matrix}\frac{\partial L}{\partial ω} = 0 \to ω = {\sum }_{i = 1}^{l} {λ}_{i} ϕ ( {x}_{i} ) \\ \frac{\partial L}{\partial b} = 0 \to {\sum }_{i = 1}^{l} {λ}_{i} = 0 , i = 1 , 2 , … , l \\ \frac{\partial L}{\partial {e}_{i}} = 0 \to {λ}_{i} = {Ce}_{i} , i = 1 , 2 , … , l \\ \frac{\partial L}{\partial {λ}_{i}} = 0 \to {ω}^{T} \cdot ϕ ( {x}_{i} ) + b + {e}_{i} - {y}_{i} = 0 , i = 1 , 2 , … , l\end{matrix}$$

By eliminating ω and e, the solution of the above equation will be:

$$[ \begin{matrix}0 & {E}^{T} \\ E & K + {C}^{- 1} I\end{matrix} ] [ \begin{matrix}b \\ λ\end{matrix} ] = [ \begin{matrix}0 \\ Y\end{matrix} ]$$

In the formula, E is [1, 1, . . . , 1]^{T}; I is an identity matrix; [λ₁, λ₂, . . . , λₗ]^{T}; Y=[Y₁, Y₂, . . . , Yₗ]^{T}; K is a radial basis kernel function, and the expression of K is:

$$K ( x , {x}_{i} ) = exp [ \frac{- {‖ x - {x}_{i} ‖}^{2}}{2 {σ}^{2}} ]$$

In the formula, x is an input variable, xᵢ is a center of the ith radial basis function, σ is a standardized parameter and ∥x−xᵢ∥ is the norm of x−xᵢ.

Finally, the optimal linear regression estimating function of the least square SVM forecasting model is obtained as follows:

$$f ( x ) = {\sum }_{i = 1}^{l} {λ}_{i} K ( x , {x}_{i} ) + b . \qquad$$

Furthermore, according to the obtained similar daily load set of the date to be forecast, constructing and training a least-square SVM (support vector machine) forecasting model:

The similar daily load set and related weather information data are taken as the input variables for the least square SVM model to obtain the forecasting data as the output variable, and the forecasting data is compared with the actual data to calculate the forecasting error; the training ends if the error MAPE is less than a threshold value; otherwise the parameters are corrected and the process returns to fuzzy C-means clustering again, so as to retrain the forecasting model of the least square SVM and continuously optimize the forecasting model;

Wherein the mean absolute percentage error MAPE of the forecast data is:

$$M A P E = {\sum }_{i = 1}^{n} \vert \frac{{y}_{i} - {\hat{y}}_{i}}{{y}_{i}} \vert \times \frac{100}{n}$$

In the formula, yᵢ is the actual load value at time i, ŷᵢ is the forecast load value at time i, and n is the number of times.

Further, the weather information data related to the historical date includes the date type, the maximum and minimum temperature, and weekly attribute.

Further, preprocessing of the collected data includes: filling up missing data and correcting abnormal data, the method of which includes:

Using a linear interpolation method to process the missing data:

$${y}_{n + j} = {y}_{n} + \frac{{y}_{n + 1} - {y}_{n}}{1} \cdot j , 0 < j < 96$$

In the formula, yₙ₊ⱼ, yₙ, yₙ₊₁ are loads at time points n+j, n, and n+1, respectively;

Adopting a horizontal processing method to identify and correct abnormal data:

$$\{ \begin{matrix}\vert y ( d , t ) - y ( d , t - 1 ) \vert > {θ}_{1} \\ \vert y ( d , t ) - y ( d , t + 1 ) \vert > {θ}_{2}\end{matrix} \} \to y ( d , t ) = \frac{y ( d , t - 1 ) + y ( d , t + 1 )}{2}$$

In the formula, y(d,t) and y(d,t−1) are load values at the times t and t−1 on the dth day, respectively, and θ₁ and θ₂ are the threshold values;

The data normalization formula is as follows:

$${x}_{i}^{′} = \frac{{x}_{i} - {x}_{imin}}{{x}_{imax} - {x}_{imin}}$$

In the formula, xᵢ is the load sample data, xᵢ′ is the normalized value of the load data, xᵢₘₐₓ and xᵢₘᵢₙ are the maximum and minimum values of the load sample, respectively.

Further, when forecasting the electric vehicle charging load on the date to be forecast, the collected data on historical dates is the data on the historical dates at least 7 days ahead of the date to be forecast.

A device for clustering forecasting of the electric vehicle charging load, including:

A data acquisition module, used for collecting electric vehicle charging load data on a historical date and weather information data related to that historical date;

A data processing module, used for preprocessing and then normalizing the collected data to obtain a new data set;

An acquisition module of similar daily load set of the date to be forecast, used for performing fuzzy C-means clustering on the normalized data, and taking an actual load measurement point as a fuzzy clustering index to construct a similar daily load set of the date to be forecast;

An acquisition module of the least square SVM forecasting model, used for constructing and training a least-square SVM (support vector machine) forecasting model according to the similar daily load set;

An acquisition module of the load on the date to be forecast, used for inputting load values at the same time in three days ahead of the date to be forecast and the weather information data related to the three days into the trained least-square SVM forecasting model, and outputting a forecast load.

A computing device, including:

One or more processing units;

A storage unit, which is used for storing one or more programs,

Wherein the one or more programs are executed by the one or more processing units, so that the one or more processing units execute the method for clustering forecasting of the electric vehicle charging load.

The benefits and advantages of the present disclosure are as follows:

The present disclosure takes into consideration the factors affecting the charging load, and adopts the forecasting model based on clustering and LS-SVM to effectively improve the accuracy of the forecasting of the electric vehicle charging load. On one hand, the method for clustering forecasting of the electric vehicle charging load provided by the present disclosure is of great significance to the stable and reliable operation of the power grid, which facilitates the deployment of the power supply and demanding, realizes the effective power supply, lays a foundation for a rational planning and operation of the power grid, and provides decision-making basis for the planning management and operation scheduling of the power transmission and distribution network; on the other hand, as for electric vehicle load aggregators, the present disclosure can support the electric vehicle aggregation for participating market transactions, and may adjust and promote the implementation of demand response and the calling of load-side resources.

### BRIEF DESCRIPTION OF THE DRAWINGS

The technical scheme of the present disclosure will be further described in detail with reference to the drawings and embodiments. However, it should be understood that these drawings are only designed for the purpose of explanation, so they are not intended to limit the scope of the present disclosure. In addition, unless specifically indicated, these drawings are only intended to conceptually illustrate the structure described herein, and are not necessarily drawn to scale.

FIG. 1 is a curve comparison diagram for load forecasting by using a BP neural network and an LS-SVM method provided in an embodiment of the present disclosure;

FIG. 2 is a curve comparison diagram for load forecasting in different scenarios provided in an embodiment of the present disclosure;

FIG. 3 is a partial enlarged view of FIG. 2;

FIG. 4 is a partial enlarged view of FIG. 2;

FIG. 5 is a comparison diagram of forecast error APEs for load forecasting in different scenarios provided in an embodiment of the present disclosure.

### DETAILED DESCRIPTION OF THE EMBODIMENTS

First of all, it should be noted that the specific structure, characteristics and advantages of the present disclosure will be specifically explained by examples below, but all descriptions are for illustration only and shall not be construed as any restrictions on the present disclosure. In addition, any single technical feature described or implied in each embodiment mentioned herein, or any single technical feature displayed or implied in each drawing, can still be combined or deleted in any way among these technical features (or their equivalents), so as to obtain more other embodiments of the present disclosure that might not be directly mentioned herein.

It should be noted that the embodiments in the present disclosure and the features in the embodiments can be combined with each other without conflict.

The method for clustering forecasting of the electric vehicle charging load provided in the present disclosure includes the following steps:

Collecting electric vehicle charging load data on a historical date and weather information data related to that historical date;

Preprocessing and then normalizing the collected data to obtain a new data set;

Performing fuzzy C-means clustering on the normalized data, and taking an actual load measurement point as a fuzzy clustering index to construct a similar daily load set of the date to be forecast;

According to the similar daily load set, constructing and training a least-square SVM (support vector machine) forecasting model;

Inputting load values at the same time in three days ahead of the date to be forecast and the weather information data related to the three days into the trained least-square SVM forecasting model, and outputting a forecast load.

Furthermore, the method of performing fuzzy C-means clustering on the normalized data and taking the actual load measurement point as the fuzzy clustering index to construct the similar daily load set of the date to be forecast is as follows:

(1) A fuzzy C-means clustering model is constructed, and the measured data points of a daily load curve are taken as the characteristic quantity for fuzzy clustering:

X={x₁,x₂, . . . ,xₙ}∈R^{s}

In the formula, X is a sample set of a given load, S represents the dimension of the sample, and n is the number of samples, namely the number of load curves involved in clustering;

$$min J ( U , V ) = {\sum }_{i = 1}^{c} {\sum }_{j = 1}^{n} {u}_{ij}^{m} {d}_{ij}^{2}$$

$${\sum }_{i = 1}^{c} {𝒰}_{ij} = 1 , 1 \leq j \leq n$$

$${\sum }_{i = 1}^{n} {𝒰}_{ij} > 0 , 1 \leq i \leq c$$

In this formula, U is a fuzzy dividing matrix, V is a clustering center matrix, uᵢⱼ is the subordination of the sample xᵢ relative to the class j, dᵢⱼ is the euclidean distance from the sample xⱼ to the clustering center vᵢ, m is a fuzzy degree weighted index, which controls the fuzzy degree of clustering, and c is a cluster number of clustering.

(2) An alternating optimization strategy is adopted to solve the fuzzy C-means clustering model, so as to obtain a similar daily load set of the date to be forecast is obtained.

Further, the method of solving the fuzzy C-means clustering model by the alternating optimization strategy is as follows:

Initialization: by determining the values of c and m of the sample set X and the iterative error threshold ε, an initial subordination matrix will be U⁽⁰⁾=uᵢⱼ⁽⁰⁾; m is set to 2 by experience, and c is set to 2 because the electric vehicle charging load is quite different between working days and non-working days; when the iteration reaches the optimum, the result tends to be stable, so that the iteration error threshold is set to infinitesimal, wherein 0.01% is used instead of infinitesimal that ε=0.01%;

The clustering center vᵢ is determined:

$$( {v}_{i}^{( 1 )} ) = \frac{{\sum }_{j = 1}^{n} {( {u}_{ij}^{( 1 - 1 )} )}^{m} {x}_{j}}{{\sum }_{i = 1}^{n} {( {u}_{ij}^{( 1 - 1 )} )}^{m}} ( i = 1 , 2 , … , c ) \qquad$$

The subordination uᵢⱼ and objective function value min J^{(I)} are calculated:

$${u}_{i j}^{( 1 )} = \frac{1}{{\sum }_{k = 1}^{c} {( \frac{{d}_{i j}^{( 1 )}}{{d}_{k j}^{( 1 )}} )}^{\frac{2}{m - 1}}} ( i = 1 , 2 , … , c ; j = 1 , 2 , … , n ) \\ min {J}^{( 1 )} ( {U}^{( L )} , {V}^{( L )} ) = {{\sum }^{c}}_{i = 1} {{\sum }_{j = 1}}^{n} {( {u}_{ij}^{( 1 )} )}^{m} {( {d}_{i j}^{( 1 )} )}^{2} \qquad$$

Iterative error judgment: if it satisfies

max |uᵢⱼ^{l}−uᵢⱼ^{l-1}<ε

The iteration ends, or otherwise returns to calculate a new clustering center for continuing the iteration, and the sample category is determined according to the principle of maximum subordination.

Furthermore, according to the obtained similar daily load set of the date to be forecast, constructing and training a least-square SVM (support vector machine) forecasting model:

The regression estimation function is:

ƒ(x)=ω^{T}·ϕ(x)+b

Wherein ω is a weight vector; φ(x) is a mapping function; b is an offset term, and ω^{T} represents the transposition of ω. At this moment, the objective function and the constraint are:

$$min J ( ω , e ) = \frac{1}{2} {‖ ω ‖}^{2} + \frac{1}{2} C {\sum }_{i = 1}^{l} {e}_{i}^{2}$$

$$s . t . {y}_{i} = {ω}^{T} \cdot ϕ ( {x}_{i} ) + b + {e}_{i} , i = 1 , 2 , … , l$$

In this formula, eᵢ is the error; e∈R^{l×l} is the error vector; C is the penalty coefficient which affects the complexity and stability of the model. According to the reference of the prior art, the significance of over-large and over-small value setting of C can be artificially set, and the Lagrange multiplier λ can be introduced, so that λ∈R^{l×l}, in order to transform the model into an unconstrained optimization problem:

$$L ( ω , b , e , λ ) = \frac{1}{2} {‖ ω ‖}^{2} + \frac{1}{2} C {\sum }_{i = 1}^{l} {e}_{i}^{2} - {\sum }_{i = 1}^{l} {λ}_{i} [ {ω}^{T} \cdot ϕ ( {x}_{ij} ) + b + {e}_{i} ] - {y}_{i}$$

According to Karush-Kuhn-Tucker (KKT) conditions:

$$\{ \begin{matrix}\frac{\partial L}{\partial ω} = 0 \to ω = {\sum }_{i = 1}^{l} {λ}_{i} ϕ ( {x}_{i} ) \\ \frac{\partial L}{\partial b} = 0 \to {\sum }_{i = 1}^{l} {λ}_{i} = 0 , i = 1 , 2 , … , l \\ \frac{\partial L}{\partial {e}_{i}} = 0 \to {λ}_{i} = C {e}_{i} , i = 1 , 2 , … , l \\ \frac{\partial L}{\partial {λ}_{i}} = 0 \to {ω}^{T} \cdot ϕ ( {x}_{i} ) + b + {e}_{i} - {y}_{i} = 0 , i = 1 , 2 , … , l\end{matrix}$$

By eliminating ω and e, the solution of the above equation will be:

$$[ \begin{matrix}0 & {E}^{T} \\ E & K + {C}^{- 1} I\end{matrix} ] [ \begin{matrix}b \\ λ\end{matrix} ] = [ \begin{matrix}0 \\ Y\end{matrix} ]$$

In the formula, E is [1, 1, . . . , 1]^{T}; I is an identity matrix; [λ₁, λ₂, . . . , λₗ]^{T}; Y=[Y₁, Y₂, . . . , Yₗ]^{T}; K is a radial basis kernel function, and the expression of K is:

$$K ( x , {x}_{i} ) = exp [ \frac{- {‖ x - {x}_{i} ‖}^{2}}{2 {σ}^{2}} ]$$

In the formula, x is the input variable, which is the measured load values at several time points, the maximum and minimum temperatures in one day, the date attribute, the weekly attribute, and the load values at the same time in three days ahead of the date to be forecast, xᵢ is the center of the ith radial basis function, σ is the standardized parameter and ∥x−xᵢ∥ is the norm of x−xᵢ;

Finally, the optimal linear regression estimating function of the least square SVM forecasting model is obtained as follows:

$$f ( x ) = {\sum }_{i = 1}^{l} {λ}_{i} K ( x , {x}_{i} ) + b .$$

Furthermore, according to the obtained similar daily load set of the date to be forecast, constructing and training a least-square SVM (support vector machine) forecasting model:

The similar daily load set and related weather information data are taken as the input variables for the least square SVM model to obtain the forecasting data as the output variable, and the forecasting data is compared with the actual data to calculate the forecasting error; the training ends if the error MAPE is less than a threshold value; otherwise the parameters are corrected and the process returns to fuzzy C-means clustering again, so as to retrain the forecasting model of the least square SVM and continuously optimize the forecasting model;

Wherein the mean absolute percentage error MAPE of the forecast data is:

$$M A P E = {\sum }_{i = 1}^{n} \vert \frac{{y}_{i} - {\hat{y}}_{i}}{{y}_{i}} \vert \times \frac{100}{n}$$

In the formula, yᵢ is the actual load value at time i, ŷᵢ is the forecast load value at time i, and n is the number of times;

Further, the weather information data related to the historical date includes the date type, the maximum and minimum temperature, and weekly attribute.

Further, preprocessing of the collected data includes: filling up missing data and correcting abnormal data, the method of which includes:

Using a linear interpolation method to process the missing data:

$${y}_{n + j} = {y}_{n} + \frac{{y}_{n + 1} - {y}_{n}}{1} \cdot j , 0 < j < 96$$

In the formula, yₙ₊ⱼ, yₙ, yₙ₊₁ are loads at time points n+j, n, and n+1, respectively;

Adopting a horizontal processing method to identify and correct abnormal data:

$$\{ \begin{matrix}\vert y ( d , t ) y ( d , t - 1 ) \vert > {θ}_{1} \\ \vert y ( d , t ) y ( d , t + 1 ) \vert > {θ}_{2}\end{matrix} \} \to y ( d , t ) = \frac{y ( d , t - 1 ) + y ( d , t + 1 )}{2}$$

In the formula, y(d,t) and y(d,t−1) are load values at the times t and t−1 on the dth day, respectively, and θ₁ and θ₂ are the threshold values; θ₁ and θ₂ reflect the change of load, which may be selected manually according to historical experience. By reference to relevant literatures, θ₁=0.05*(y(d,t−1)), and θ₂=0.05*(y(d,t+1)) here.

The data normalization formula is as follows:

$${x}_{i}^{′} = \frac{{x}_{i} - {x}_{i min}}{{x}_{i max} - {x}_{i min}}$$

In the formula, xᵢ is the load sample data, xᵢ′ is the normalized value of the load data, xᵢₘₐₓ and xᵢₘᵢₙ are the maximum and minimum values of the load sample, respectively.

Further, when forecasting the electric vehicle charging load on the date to be forecast, the collected data on historical dates is the data on the historical dates at least 7 days ahead of the date to be forecast.

A clustering forecasting device of the electric vehicle charging load is provided, including:

A data acquisition module, used for collecting electric vehicle charging load data on a historical date and weather information data related to that historical date;

A data processing module, used for preprocessing and then normalizing the collected data to obtain a new data set;

An acquisition module of similar daily load set of the date to be forecast, used for performing fuzzy C-means clustering on the normalized data, and taking an actual load measurement point as a fuzzy clustering index to construct a similar daily load set of the date to be forecast;

An acquisition module of the least square SVM forecasting model, used for constructing and training a least-square SVM (support vector machine) forecasting model according to the similar daily load set;

An acquisition module of the load on the date to be forecast, used for inputting load values at the same time in three days ahead of the date to be forecast and the weather information data related to the three days into the trained least-square SVM forecasting model, and outputting a forecast load.

A computing device, including:

One or more processing units;

A storage unit, which is used for storing one or more programs,

Wherein the one or more programs are executed by the one or more processing units, so that the one or more processing units execute the method for clustering forecasting of the electric vehicle charging load. It should be noted that the computing device may include, but not limited to, a processing unit and a storage unit. It can be understood by those skilled in the art that the computing device includes a processing unit and a storage unit, which does not constitute a limitation on the computing device, while the computing device may include more components, or the combination of some components or different components. For example, the computing device may also include input and output devices, network access devices, buses, etc.

A computer readable storage medium with nonvolatile program code executable by a processor is provided, wherein the computer program, when executed by the processor, implements the above-mentioned method for clustering forecasting of electric vehicle charging load. It should be noted that the readable storage medium can be, for example, but not limited to, electrical, magnetic, optical, electromagnetic, infrared, or semiconductor systems, equipment, or devices, or any combination of the above. The program contained in the readable medium can be transmitted by any suitable medium, including but not limited to wireless, wired, optical cable, RF, etc., or any suitable combination of the above. For example, the program code for executing the operation of the present disclosure can be written in any combination of one or more programming languages which include object-oriented programming languages such as Java, C++, and conventional procedural programming languages such as the C language or similar programming languages. The program code can be entirely executed on the user computing device, partially executed on the user device, executed as a single separate software package, or completely executed on a remote computing device or server. In a case involving a remote computing device, the remote computing device may be connected to a user computing device through any kind of networks, including a local area network (LAN) or a wide area network (WAN), or may be connected to an external computing device (e.g., connected through the Internet by an Internet service provider).

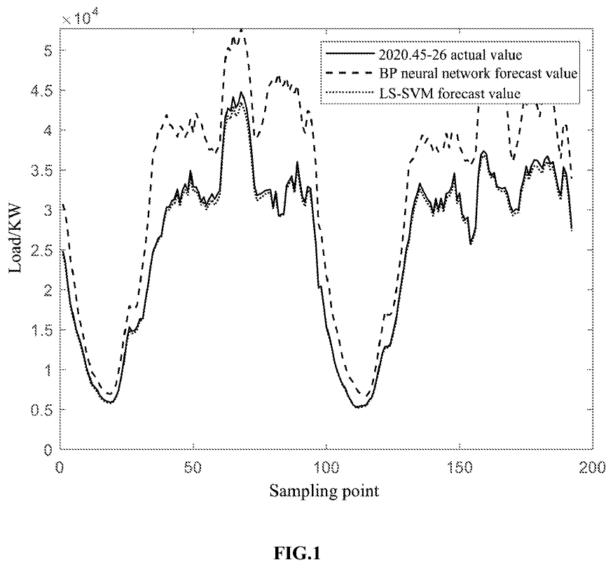

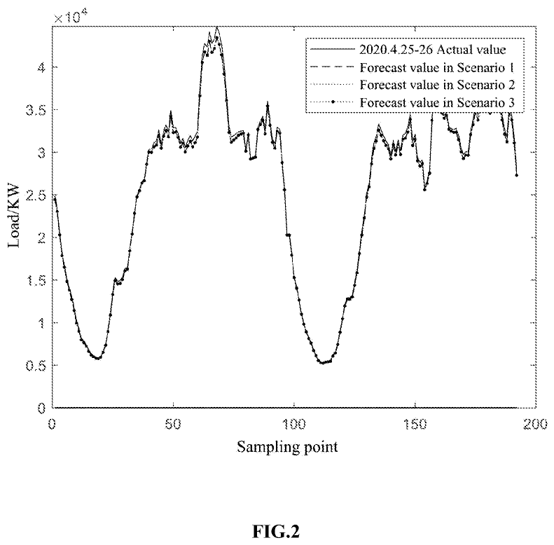

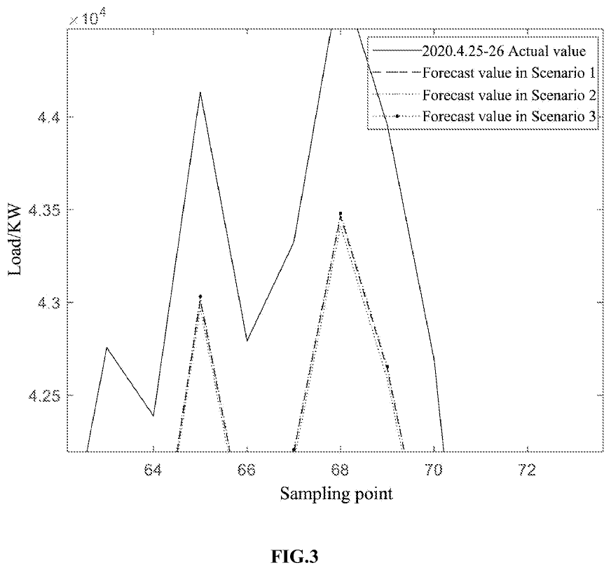

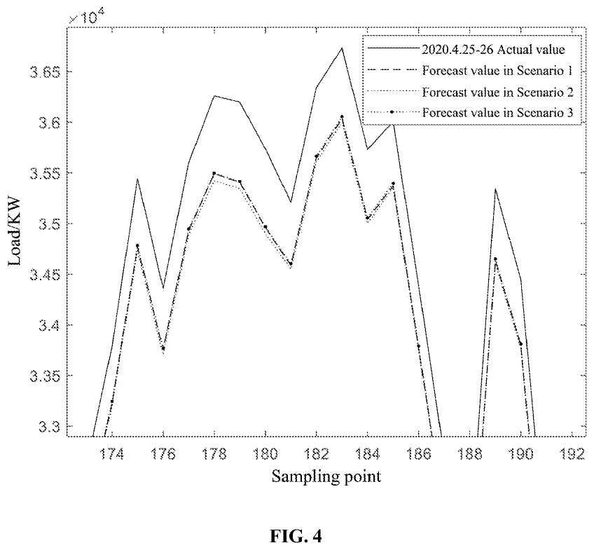

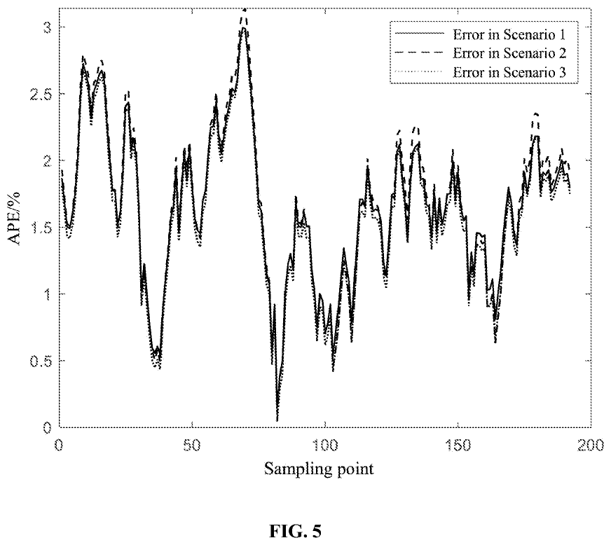

For example, in this embodiment, taking the forecasting of electric vehicle charging load in North China for an example, the charging load data from Nov. 16, 2019 to Apr. 30, 2020 is taken as a sample. Taking fifteen minutes as a step and a total of 96 sampling points per day, the clustering forecasting of electric vehicle charging load is simulated by taking into consideration the similar dates and weather factors, and the results are as shown in FIGS. 1-5.

In order to compare the effectiveness of the forecasting model, the load data of non-working days in April acts as the test set firstly, and then a forecasting result comparison is performed between a BP neural network and an LS-SVM model:

TABLE 1
MAPE Comparison between BP Neural Network Forecasting and
LS-SVM Forecasting

| | Forecasting Method | |
|---|---|---|
| Forecasting Date | BP | LS-SVM |
| Apr. 4, 2020 | 31.61% | 1.57% |
| Apr. 5, 2020 | 10.10% | 1.44% |
| Apr. 11, 2020 | 26.49% | 1.81% |
| Apr. 12, 2020 | 26.22% | 1.59% |
| Apr. 18, 2020 | 25.91% | 1.79% |
| Apr. 19, 2020 | 19.91% | 1.33% |
| Apr. 25, 2020 | 27.34% | 1.65% |
| Apr. 26, 2020 | 27.81% | 1.54% |

In the load forecasting of non-working days in April 2020, the MAPEs forecast by the BP neural network are mostly above 20%, while the MAPEs forecast by the LS-SVM are less than 2%.

Three scenarios are assumed to forecast the electric vehicle charging load on April 25th and 26th respectively:

Scenario 1: a single LS-SVM forecasting model is used, and the input variables are the date type, the maximum and minimum temperatures, and load data at the same time on 1st, 2nd, and 3rd days ahead of the non-working day to be forecast;

Scenario 2: a combination of FCM and LS-SVM forecasting model is used, and the input variables are the load data at the same time on 1st, 2nd, and 3rd days ahead of the non-working day to be forecast;

Scenario 3: a combination of FCM and LS-SVM forecasting model is used, and the input variables are the date type, the maximum and minimum temperatures, and load data at the same time on 1st, 2nd, and 3rd days ahead of the non-working day to be forecast.

It should be noted that the LS-SVM forecasting model refers to the least square SVM forecasting model, and FCM refers to the fuzzy C-means clustering.

It can be seen that in the forecasting of electric vehicle charging load on Apr. 25 and 26, 2020, the forecasting error in Scenario 3 is obviously lower than that in the other two scenarios, and the MAPEs of the three scenarios is 1.54%, 1.56% and 1.46% respectively. Compared with Scenario 1, an FCM clustering algorithm is used additionally in Scenario 3 to extract similar daily loads in non-working days, and its forecasting error is reduced by 0.08%. Compared with Scenario 2, the influencing factors of load such as date type and temperature are considered in Scenario 3, and its forecasting error is reduced by 0.1%. The clustering forecasting method of electric vehicle charging load proposed by the present disclosure can effectively improve the forecasting accuracy of electric vehicle charging load, and provide the decision-making basis for the planning management and operation scheduling of the power transmission and distribution network.

The above-mentioned embodiments have explained the present disclosure in detail which, however, only present better embodiments of the present disclosure, and cannot be considered as limiting the implementation scope of the present disclosure. All equivalent variations and improvements carried out in accordance with the claims of the present disclosure shall still fall within the patent protection scope of the present disclosure.

1. A method for clustering forecasting of the electric vehicle charging load comprises the following steps:
Collecting electric vehicle charging load data on a historical date and weather information data related to that historical date;
Preprocessing and then normalizing the collected data to obtain a new data set;
Performing fuzzy C-means clustering on the normalized data, and taking an actual load measurement point as a fuzzy clustering index to construct a similar daily load set of the date to be forecast;
According to the similar daily load set, constructing and training a least-square SVM (support vector machine) forecasting model;
Inputting load values at the same time in three days ahead of the date to be forecast and the weather information data related to the three days into the trained least-square SVM forecasting model, and outputting a forecast load.

2. The method for clustering forecasting of the electric vehicle charging load according to claim 1, wherein the method of performing fuzzy C-means clustering on the normalized data and taking the actual load measurement point as the fuzzy clustering index to construct the similar daily load set of the date to be forecast is as follows:
(1) A fuzzy C-means clustering model is constructed, and the measured data points of a daily load curve are taken as the characteristic quantity for fuzzy clustering:
X={x₁,x₂, . . . ,xₙ}∈R^{s}
In the formula, X is a sample set of a given load, S represents the dimension of the sample, and n is the number of samples, namely the number of load curves involved in clustering;
$$min J ( U , V ) = {\sum }_{i = 1}^{c} {\sum }_{{ }^{j = 1}}^{n} {u}_{ij}^{m} , {d}_{ij}^{2}$$
$${\sum }_{i = 1}^{c} {u}_{ij} = 1 , 1 \leq j \leq n$$
$${\sum }_{i = 1}^{n} {u}_{ij} > 0 , 1 \leq i \leq c$$
In this formula, U is a fuzzy dividing matrix, V is a clustering center matrix, uᵢⱼ is the subordination of the sample xᵢ relative to the class j, dᵢⱼ the euclidean distance from the sample xⱼ to the clustering center vᵢ, m is a fuzzy degree weighted index, which controls the fuzzy degree of clustering, and c is a cluster number of clustering.
(2) An alternating optimization strategy is adopted to solve the fuzzy C-means clustering model, so as to obtain a similar daily load set of the date to be forecast is obtained.

3. The method for clustering forecasting of the electric vehicle charging load according to claim 2, wherein a method of solving the fuzzy C-means clustering model by the alternating optimization strategy is as follows:
Initialization: by determining the values of c and m of the sample set X and the iterative error threshold ε, an initial subordination matrix will be U⁽⁰⁾=uᵢⱼ⁽⁰⁾;
The clustering center vᵢ is determined:
$${v}_{i}^{( l )} = \frac{{\sum }_{j = 1}^{n} {( {u}_{ij}^{( l - 1 )} )}^{m} xj}{{\sum }_{i = 1}^{n} {( {u}_{ij}^{( l - 1 )} )}^{m}} ( i = 1 , 2 , … , c )$$
The subordination uᵢⱼ and objective function value min J^{(l)} are calculated:
$${u}_{i j}^{( l )} = \frac{1}{{\sum }_{k = 1}^{c} {( \frac{{d}_{ij}^{( l )}}{{d}_{kj}^{( l )}} )}^{\frac{2}{m - 1}}} ( i = 1 , 2 , … , c ; j = 1 , 2 , … , n )$$
$${min}_{J}^{( l )} ( {U}^{( L )} , {V}^{( L )} ) = {\sum }_{i = 1}^{c} {\sum }_{j = 1}^{n} {( {u}_{ij}^{( l )} )}^{m} {( {d}_{ij}^{( l )} )}^{2}$$
Iterative error judgment: if it satisfies
max |uᵢⱼ^{l}−uᵢⱼ^{l-1}|<ε
The iteration ends, or otherwise returns to calculate a new clustering center for continuing the iteration, and the sample category is determined according to the principle of maximum subordination.

4. The method for clustering forecasting of the electric vehicle charging load according to claim 3, wherein according to the obtained similar daily load set of the date to be forecast, a least-square SVM (support vector machine) forecasting model is constructed and trained:
The regression estimation function is:
f(x)=ω^{T}·ϕ(x)+b
Wherein ω is a weight vector; φ(x) is a mapping function; b is an offset term, and ω^{T} represents the transposition of ω. At this moment, the objective function and the constraint are:
$$min J ( ω , e ) = \frac{1}{2} {‖ ω ‖}^{2} + \frac{1}{2} C {\sum }_{i = 1}^{l} {e}_{i}^{2}$$
$$s . t . {y}_{i} = {ω}^{T} \cdot ϕ ( {x}_{i} ) + b + {e}_{i} , i = 1 , 2 , … , l$$
In this formula, eᵢ is the error; e∈R^{l×l} is the error vector; C is the penalty coefficient, and the Lagrange multiplier λ can be introduced, so that λ∈R^{l×l}, in order to transform the model into an unconstrained optimization problem:
$$L ( ω , b , e , λ ) = \frac{1}{2} {‖ ω ‖}^{2} + \frac{1}{2} C {\sum }_{i = 1}^{l} {e}_{i}^{2} - {\sum }_{i = 1}^{l} {λ}_{i} [ {ω}^{T} \cdot ϕ ( {x}_{i} ) + b + {e}_{i} ] - {y}_{i}$$
$$According to Karush \text{-} Kuhn \text{-} Tucker ( KKT ) conditions \text{:}$$
$$\{ \begin{matrix}\frac{\partial L}{\partial ω} = 0 \to ω = {\sum }_{i = 1}^{l} {λ}_{i} ϕ ( {x}_{i} ) \\ \frac{\partial L}{\partial b} = 0 \to {\sum }_{i = 1}^{l} {λ}_{=} = 0 , i = 1 , 2 , … , l \\ \frac{\partial L}{\partial {e}_{i}} = 0 \to {λ}_{i} = C {e}_{i} , i = 1 , 2 , … , l \\ \frac{\partial L}{\partial {λ}_{i}} = 0 \to {ω}^{T} \cdot ϕ ( {x}_{i} ) + b + {e}_{i} - {y}_{i} = 0 , i = 1 , 2 , … , l\end{matrix}$$
By eliminating ω and e, the solution of the above equation will be:
$$[ \begin{matrix}0 & {E}^{T} \\ E & K + {C}^{- 1} I\end{matrix} ] [ \begin{matrix}b \\ λ\end{matrix} ] = [ \begin{matrix}0 \\ Y\end{matrix} ]$$
In the formula, E is [1, 1, . . . , 1]^{T}; I is an identity matrix; [λ₁, λ₂, . . . , λₗ]^{T}; Y=[Y₁, Y₂, . . . , Yₗ]^{T}; K is a radial basis kernel function, and the expression of K is:
$$K ( x , {x}_{i} ) = exp [ \frac{- {‖ x - {x}_{i} ‖}^{2}}{2 {σ}^{2}} ]$$
In the formula, x is an input variable, xᵢ is a center of the ith radial basis function, σ is a standardized parameter and ∥x−xᵢ∥ is the norm of x−xᵢ;
Finally, the optimal linear regression estimating function of the least square SVM forecasting model is obtained as follows:
$$f ( x ) = {\sum }_{i = 1}^{l} {λ}_{i} K ( x , {x}_{i} ) + b .$$

5. The method for clustering forecasting of the electric vehicle charging load according to claim 4, wherein according to the obtained similar daily load set of the date to be forecast, a least-square SVM (support vector machine) forecasting model is constructed and trained:
The similar daily load set and related weather information data are taken as the input variables for the least square SVM model to obtain the forecasting data as the output variable, and the forecasting data is compared with the actual data to calculate the forecasting error; the training ends if the error MAPE is less than a threshold value; otherwise the parameters are corrected and the process returns to fuzzy C-means clustering again, so as to retrain the forecasting model of the least square SVM and continuously optimize the forecasting model;
Wherein the mean absolute percentage error MAPE of the forecast data is:
$$M A P E = {\sum }_{i = 1}^{n} \vert \frac{{y}_{i} - {\hat{y}}_{i}}{{y}_{i}} \vert \times \frac{100}{n}$$
In the formula, yᵢ is the actual load value at time i, [symbol] is the forecast load value at time i, and n is the number of times.

6. The method for clustering forecasting of the electric vehicle charging load according to claim 1, wherein the weather information data related to the historical date comprises the date type, the maximum and minimum temperature, and weekly attribute.

7. The method for clustering forecasting of the electric vehicle charging load according to claim 1, wherein preprocessing of the collected data comprises: filling up missing data and correcting abnormal data, the method of which includes:
Using a linear interpolation method to process the missing data:
$${y}_{n + j} = {y}_{n} + \frac{{y}_{n + 1} - {y}_{n}}{1} \cdot j , 0 < j < 96$$
In the formula, yₙ₊ⱼ, yₙ, yₙ₊₁ are loads at time points n+j, n, and n+1, respectively;
Adopting a horizontal processing method to identify and correct abnormal data:
$$\{ \begin{matrix}\vert y ( d , t ) - y ( d , t - l ) \vert > {θ}_{1} \\ \vert y ( d , t ) - y ( d , t + l ) \vert > {θ}_{2}\end{matrix} \} \to y ( d , t ) = \frac{y ( d , t - 1 ) + y ( d , t + 1 )}{2}$$
In the formula, y(d,t) are y(d,t−1) load values at the times t and t−1 on the dth day, respectively, and θ₁ and θ₂ are the threshold values;
The data normalization formula is as follows:
$${x}_{i}^{′} = \frac{{x}_{i} - {x}_{i min}}{{x}_{i min} - {x}_{i min}}$$
In the formula, xᵢ is the load sample data, xᵢ′ is the normalized value of the load data, xᵢₘₐₓ and xᵢₘᵢₙ are the maximum and minimum values of the load sample, respectively.

8. The method for clustering forecasting of the electric vehicle charging load according to claim 1, wherein when forecasting the electric vehicle charging load on the date to be forecast, the collected data on historical dates is the data on the historical dates at least 7 days ahead of the date to be forecast.

9. A device for clustering forecasting of electric vehicle charging load, comprising:
A data acquisition module, used for collecting electric vehicle charging load data on a historical date and weather information data related to that historical date;
A data processing module, used for preprocessing and then normalizing the collected data to obtain a new data set;
An acquisition module of similar daily load set of the date to be forecast, used for performing fuzzy C-means clustering on the normalized data, and taking an actual load measurement point as a fuzzy clustering index to construct a similar daily load set of the date to be forecast;
An acquisition module of the least square SVM forecasting model, used for constructing and training a least-square SVM (support vector machine) forecasting model according to the similar daily load set;
An acquisition module of the load on the date to be forecast, used for inputting load values at the same time in three days ahead of the date to be forecast and the weather information data related to the three days into the trained least-square SVM forecasting model, and outputting a forecast load.

10. A computing device, comprising:
One or more processing units;
A storage unit, which is used for storing one or more programs;
Wherein the one or more programs are executed by the one or more processing units, so that the one or more processing units execute the method according to claim 1.

11. The computing device according to claim 10, wherein the method of performing fuzzy C-means clustering on the normalized data and taking the actual load measurement point as the fuzzy clustering index to construct the similar daily load set of the date to be forecast is as follows:
(1) A fuzzy C-means clustering model is constructed, and the measured data points of a daily load curve are taken as the characteristic quantity for fuzzy clustering:
X={x₁,x₂, . . . ,xₙ}∈R^{s}
In the formula, X is a sample set of a given load, S represents the dimension of the sample, and n is the number of samples, namely the number of load curves involved in clustering;
$$min J ( U , V ) = {\sum }_{i = 1}^{c} {\sum }_{j = 1}^{n} {u}_{ij}^{m} {d}_{ij}^{2}$$
$${\sum }_{i = 1}^{c} {u}_{ij} = 1 , 1 \leq j \leq n$$
$${\sum }_{i = 1}^{n} {u}_{ij} > 0 , 1 \leq i \leq c$$
In this formula, U is a fuzzy dividing matrix, V is a clustering center matrix, uᵢⱼ is the subordination of the sample xᵢ relative to the class j, dᵢⱼ is the euclidean distance from the sample xⱼ to the clustering center vᵢ, m is a fuzzy degree weighted index, which controls the fuzzy degree of clustering, and c is a cluster number of clustering.
(2) An alternating optimization strategy is adopted to solve the fuzzy C-means clustering model, so as to obtain a similar daily load set of the date to be forecast is obtained.

12. The computing device according to claim 11, wherein a method of solving the fuzzy C-means clustering model by the alternating optimization strategy is as follows:
Initialization: by determining the values of c and m of the sample set X and the iterative error threshold ε, an initial subordination matrix will be U⁽⁰⁾=uᵢⱼ⁽⁰⁾;
The clustering center vᵢ is determined:
$${v}_{i}^{( l )} = \frac{{{\sum }^{n}}_{j = 1} {( {u}_{ij}^{( l - 1 )} )}^{m} {x}_{j}}{{\sum }_{i = 1}^{n} {( {u}_{i j}^{( l - 1 )} )}^{m}} ( i = 1 , 2 , … , c )$$
The subordination uᵢⱼ and objective function value min J^{(l)} are calculated:
$${u}_{ij}^{( l )} = \frac{1}{{{\sum }_{k = 1}}^{c} {( \frac{{d}_{ij}^{( l )}}{{d}_{k j}^{( l )}} )}^{\frac{2}{m - 1}}} ( i = 1 , 2 , … , c ; j = 1 , 2 , … , n )$$
$$min {J}^{( l )} ( {U}^{( L )} , {V}^{( L )} ) = {\sum }_{i = 1}^{c} {\sum }_{j = 1}^{n} {( {u}_{ij}^{( l )} )}^{m} {( {d}_{ij}^{( l )} )}^{m} {( {d}_{ij}^{( l )} )}^{2}$$
Iterative error judgment: if it satisfies
max |uᵢⱼ^{l}−uᵢⱼ^{l-1}|<ε
The iteration ends, or otherwise returns to calculate a new clustering center for continuing the iteration, and the sample category is determined according to the principle of maximum subordination.

13. The computing device according to claim 12, wherein according to the obtained similar daily load set of the date to be forecast, a least-square SVM (support vector machine) forecasting model is constructed and trained:
The regression estimation function is:
ƒ(x)=ω^{T}·ϕ(x)+b
Wherein ω is a weight vector; φ(x) is a mapping function; b is an offset term, and ω^{T} represents the transposition of ω. At this moment, the objective function and the constraint are:
$$Min J ( ω , e ) = \frac{1}{2} {‖ ω ‖}^{2} + \frac{1}{2} C {\sum }_{i = 1}^{l} {e}_{i}^{2}$$
$$s . t . {y}_{i} = {ω}^{T} \cdot ϕ ( {x}_{i} ) + b + {e}_{l} , i = 1 , 2 , … , l$$
In this formula, eᵢ is the error; e∈R^{l×l} is the error vector; C is the penalty coefficient, and the Lagrange multiplier λ can be introduced, so that λ∈R^{l×l}, in order to transform the model into an unconstrained optimization problem:
$$L ( ω , b , e , λ ) = \frac{1}{2} {‖ ω ‖}^{2} + \frac{1}{2} C {\sum }_{i = 1}^{l} {e}_{i}^{2} - {\sum }_{i = 1}^{l} {λ}_{i} [ {ω}^{T} \cdot ϕ ( {x}_{i} ) + b + {e}_{i} ] - {y}_{i}$$
According to Karush-Kuhn-Tucker (KKT) conditions:
$$\{ \begin{matrix}\frac{\partial L}{\partial ω} = 0 \to ω = {\sum }_{i = 1}^{l} {λ}_{i} ϕ ( {x}_{i} ) \\ \frac{\partial L}{\partial b} = 0 \to {\sum }_{i = 1}^{l} {λ}_{i} = 0 , i = 1 , 2 , … , l \\ \frac{\partial L}{\partial {e}_{i}} = 0 \to {λ}_{i} = C {e}_{i} , i = 1 , 2 , … , l \\ \frac{\partial L}{\partial {λ}_{i}} = 0 \to {ω}^{T} \cdot ϕ ( {x}_{i} ) + b + {e}_{i} - {y}_{i} = 0 , i = 1 , 2 , … , l\end{matrix}$$
By eliminating ω and e, the solution of the above equation will be:
$$[ \begin{matrix}0 & {E}^{T} \\ E & K + {C}^{- 1} I\end{matrix} ] [ \begin{matrix}b \\ λ\end{matrix} ] = [ \begin{matrix}0 \\ Y\end{matrix} ]$$
In the formula, E is [1, 1, . . . , 1]^{T}; I is an identity matrix; [λ₁, λ₂, . . . , λₗ]^{T}; Y=[Y₁, Y₂, . . . , Yₗ]^{T}; K is a radial basis kernel function, and the expression of K is:
$$K ( x , {x}_{i} ) = exp [ \frac{- {‖ x - {x}_{i} ‖}^{2}}{2 {σ}^{2}} ]$$
In the formula, x is an input variable, xᵢ is a center of the ith radial basis function, σ is a standardized parameter and ∥x−xᵢ∥ is the norm of x−xᵢ;
Finally, the optimal linear regression estimating function of the least square SVM forecasting model is obtained as follows:
$$f ( x ) = {\sum }_{i = 1}^{l} {λ}_{i} K ( x , {x}_{i} ) + b .$$

14. The computing device according to claim 13, wherein according to the obtained similar daily load set of the date to be forecast, a least-square SVM (support vector machine) forecasting model is constructed and trained:
The similar daily load set and related weather information data are taken as the input variables for the least square SVM model to obtain the forecasting data as the output variable, and the forecasting data is compared with the actual data to calculate the forecasting error; the training ends if the error MAPE is less than a threshold value; otherwise the parameters are corrected and the process returns to fuzzy C-means clustering again, so as to retrain the forecasting model of the least square SVM and continuously optimize the forecasting model;
Wherein the mean absolute percentage error MAPE of the forecast data is:
$$M A P E = {\sum }_{i = 1}^{n} \vert \frac{{y}_{i} - {\hat{y}}_{i}}{{y}_{i}} \vert \times \frac{100}{n}$$
In the formula, yᵢ is the actual load value at time i, [symbol] is the forecast load value at time i, and n is the number of times.

15. The computing device according to claim 10, wherein the weather information data related to the historical date comprises the date type, the maximum and minimum temperature, and weekly attribute.

16. The computing device according to claim 10, wherein preprocessing of the collected data comprises: filling up missing data and correcting abnormal data, the method of which includes:
Using a linear interpolation method to process the missing data:
$${y}_{n + j} = {y}_{n} + \frac{{y}_{n + 1} - {y}_{n}}{1} \cdot j , 0 < j < 96$$
In the formula, yₙ₊ⱼ, yₙ, yₙ₊₁ are loads at time points n+j, n, and n+1, respectively;
Adopting a horizontal processing method to identify and correct abnormal data:
$$\{ \begin{matrix}\vert y ( d , t ) - y ( d , t - l ) \vert > {θ}_{1} \\ \vert y ( d , t ) - y ( d , t + l ) \vert > {θ}_{2}\end{matrix} \} \to y ( d , t ) = \frac{y ( d , t - 1 ) + y ( d , t + 1 )}{2}$$
In the formula, y(d,t) are y(d,t−1) are load values at the times t and t−1 on the dth day, respectively, and θ₁ and θ₂ are the threshold values;
The data normalization formula is as follows:
$${x}_{i}^{′} = \frac{{x}_{i} - {x}_{i min}}{{x}_{i min} - {x}_{i min}}$$
In the formula, xᵢ is the load sample data, xᵢ′ is the normalized value of the load data, xᵢₘₐₓ and xᵢₘᵢₙ are the maximum and minimum values of the load sample, respectively.

17. The computing device according to claim 10, wherein when forecasting the electric vehicle charging load on the date to be forecast, the collected data on historical dates is the data on the historical dates at least 7 days ahead of the date to be forecast.
